(19) United States
(12) Patent Application Publication
(10) Pub. No.: US 2001/0002464 A1
(43) Pub. Date: May 31, 2001

(54) Scanner-based automated service scheduling, management and billing system

(76) Inventor: Joseph P. Hogan, Pittsburgh, PA (US)

Correspondence Address: Law Offices of K. Patrick McKay, PE, Esq., Unicom Plaza, 3755 Library Rd., Pittsburgh, PA, 15234, US

(21) Appl. No.: 09/753,180

(22) Filed: Jan. 2, 2001

Related U.S. Application Data
(63) Continuation-in-part of application No. 09/266,649, filed on Mar. 11, 1999.

(51) Int. Cl. G06F 11/30

(52) U.S. Cl. 702/186

(57) ABSTRACT

A scanner-based management system and method for efficiently monitoring and controlling the servicing of equipment using a network such as the Internet. A computer-enhanced, hand-held scanner is loaded with the applicable component identification, for instance, by name, size, type, test dates, history of service, etc. As the service person conducts business, a piece of equipment is scanned-in using a standard bar code label. The data is downloaded into a computer and the billings and reports prepared and adapted for viewing and access over a computer network. The company website and main access database hosts the collected data for access by either the service client or any end-user utilizing the services provided by the service client, such that the end-user can perform his or her own service task management and monitor the information organized and made accessible by the company website.

### SPECIFIC REFERENCE

The present application is a continuation-in-part of application Ser. No. 09/266,649, filed Mar. 11, 1999 for a scanner-based automated service scheduling, management and billing system.

### BACKGROUND OF THE INVENTION

1. Field of the Invention:

The present invention relates to a system and method for tracking and monitoring the servicing of equipment using hand-held scanners, and allowing end-users and clients to access the data and reports using a network such as the Internet.

2. Description of the Related Art:

Scanner units are used to scan encoded information contained in a selected bar code. The prior art shows a system for scanners used in supermarket checkouts. Further delineated is the use of interrelating scanner data from a supermarket checkout counter with demographic and/or economic data concerning individual customers, to generate a demographic and economic analysis of sales with respect to specific supermarket items.

Particularly taught are methods for automatically generating recommended actions in response to diagnosis of malfunctions in equipment. These systems use an expert system rulebase. After a diagnosis is evaluated as true, the corresponding text modules are evaluated to produce a recommended action.

Feedback and evaluation systems are shown and taught, such as data processing and retrieval systems for use in a self-checkout system. These are particularly utilized in a retail facility. In the event errors occur during data entry or in the entry of the authorization codes, a customer service desk is provided which assists the customer in completing the transaction.

Property inspection data entry devices for collecting and storing inspection data during the inspection of a property are taught wherein the property inspection data entry device typically includes a scanner, which is responsive to bar-coded labels. A host computer can then sort the data according to one or more predetermined parameters such that a number of customized reports and/or work orders can be generated.

U.S. Pat. No. 5,920,846 teaches a system and method for processing a service request for installation, maintenance or repair of a local loop maintained by a telecommunications company. The system includes a computer network that allows for inputting and processing customer information.

U.S. Pat. No. 5,959,275 shows a system and method for registering and tracking network equipment at the circuit card level. A computer network server is coupled with an equipment database that contains location and identification data for telecommunication network assets. Users visit remote sites and register network assets in real-time, while walking through the equipment bays.

The prior art thereby demonstrates the extensive use of scanners, particularly as input devices. The prior art does not teach the overall management of a scanner and Internet-based service system through the use of a computer and a network as shall be fully disclosed and taught herein. The failure of existing systems to satisfy the complete needs of an Internet-based system for equipment service task management for end-user and remote client access is now satisfied by the present invention.

### SUMMARY OF THE INVENTION

It is the objective of the present invention to completely and remotely automate the method of equipment servicing and task management by implementing an efficient, scanner-based system that allows access to servicing and maintenance reports by end-users and remote clients.

It is further an objective of the present invention to couple barcode data read from hand-held scanners to a network such as the internet.

It is a third objective of the present invention to automatically generate reports and invoices based on the scanner data and allow the remote viewing of the invoices and reports on a network application such as a web browser.

Accordingly, what is provided is a method and system using a computer and a network for tracking and monitoring data collected from a hand-held scanner. Generally, both the system and method provide for receiving and organizing data, wherein the data is associated with equipment information captured from a barcode label read by the hand-held scanner. Upon being placed into a main access database within the company computer, the collected data is arranged into an online report accessible over a network such as the Internet. A service client can then be allowed to host the online report and an end-user is allowed to login and access the online report via the service client, which displays, for example, the test dates, the type of equipment, and the location of the equipment being serviced. In this manner, a service client employing the use of the hand-held scanner to perform service tasks, may choose to further allow an end-user, or third party customer to do the same, which data is accessed and organized via the main company server and website.

### BRIEF DESCRIPTION OF THE DRAWINGS

FIG. 1 is a block diagram showing the overall process of a technician's initial start of a workday and the resulting time management.

FIG. 2 is a block diagram showing the methodology upon a technician's arrival at a customer location for testing and servicing.

FIG. 3 is a block diagram showing the process of the resulting output production.

FIG. 4 is a flow diagram showing the server and information path from both an end-user and a service client and from the data collected from each using a scanned barcode.

FIG. 5 is a flow diagram showing the report generation path by the main company server and the service client to be accessed by the end-user.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated device, and such further applications of the principles of the invention illustrated herein, as would normally occur to persons skilled in the art to which the invention relates.

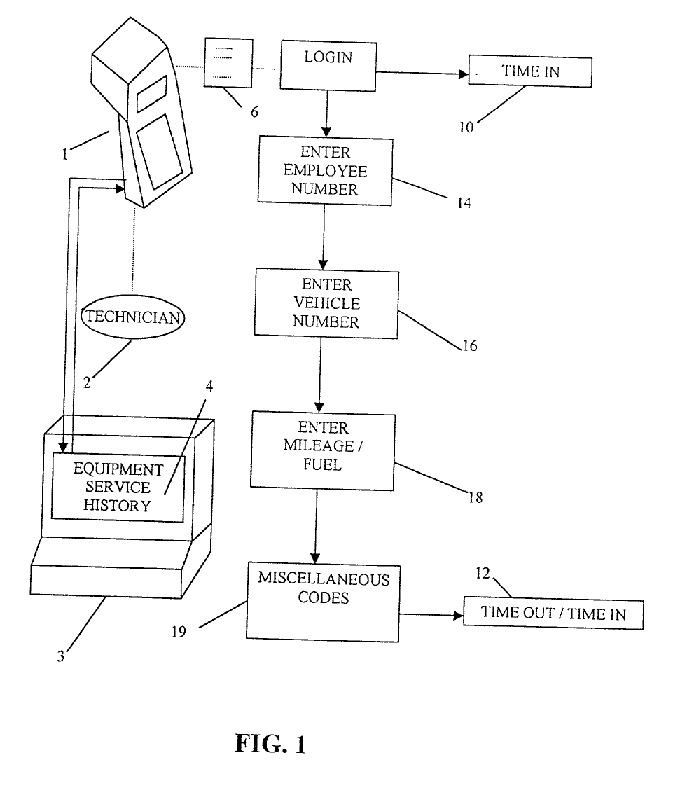

Referring to FIG. 1, a hand-held scanner 1 is employed by a technician 2. The scanner 1 is equipped with computer memory, which is related back to a computer 3. The scanner 1 used in this preferred embodiment can be of the type similar to the Dolphin brand name hand-held scanners. The computer 3, as known in the art, generally comprises an input device, and a display device such as a monitor. The computer 3 also typically comprises a random access memory (RAM), a read only memory (ROM), a central processing unit (CPU), and a storage device such as a hard disk drive or a floppy drive. In the present embodiment as will be disclosed, the computer further comprises a web browser installed within the CPU for allowing the viewing of information retrieved via a network such as the internet on the display device. A network may also be construed as a local, ethernet connection or a global digital network. In the preferred embodiment and as generally known in the art, the information can be retrieved by visiting a website's URL or address (http:// . . . ) and the information can be sent using file transfer protocol (FTP) as shall be further described.

Each scanner 1 has the capacity to hold routing information for an entire month, or some other pre-determined time period. For purposes of this embodiment, the elected time period is one month, but any other period of time does not further restrict the subject matter of the present invention.

The scanner 1 is utilized to track every aspect of the workday for the technician 2. It can be understood, then, that there are a number of technicians employed, but each individually controlled as follows. The scanner 1 acts as the employee time card, substantiating both time-in 10 and time-out 12 for the day. Upon arriving to work, the technician 2 logs into his or her assigned scanners 1. The technician 2 is prompted to enter his or her employee number 14. The employee number 14 tracks exact punch in and punch out times for each employee. For office employees and others who do not take a scanner 1, a punch in and out occurs via the computer 3. Both the scanners 1 and the computer 3 will be linked to payroll program.

A vehicle number 16 is recorded via the scanner 1 prompting the employee to enter it at the start of the day. Prior to leaving the company premises the scanner 1 prompts the technician 2 to enter the mileage (optional) 18 to record the total mileage traveled between stops as well as a true departure time and arrival time back at the building. When departing or arriving back to the facility each technician 2 must scan a corresponding barcode on his or her master barcode definition list 6. By entering the mileage at each destination track: total miles, stops per mile, and any travel distances are recorded if charges are chosen by the customer for travel distances. The employees must also enter their lunch and breaks into the scanner via the master barcode definition list 6.

Upon obtaining fuel for vehicles, the technician 2 is again prompted to enter the mileage 18 as well as the total gallons of fuel including tenths, for miles per gallon for each vehicle used. The scanner 1 will also be able to handle miscellaneous codes 19 such as breakdowns, soliciting, errands within stops, etc.

The scanner 1 is uploaded the first of the month to contain all relevant customer information for the equipment to be serviced, relevant to a plurality of customer sites. The scanner 1 is programmed based on the main computer equipment service history 4. The scanner 1 carries relevant bar coded numbers for each customer site.

The technician 2 employing the scanner 1 uses a master barcode definition list 6, which contains a code for all equipment types to be serviced. The master barcode definition list 6 contains all barcodes used in servicing any equipment. For any type of service done to a particular unit, the appropriate barcode is scanned immediately, establishing for the service, for that date, the required input.

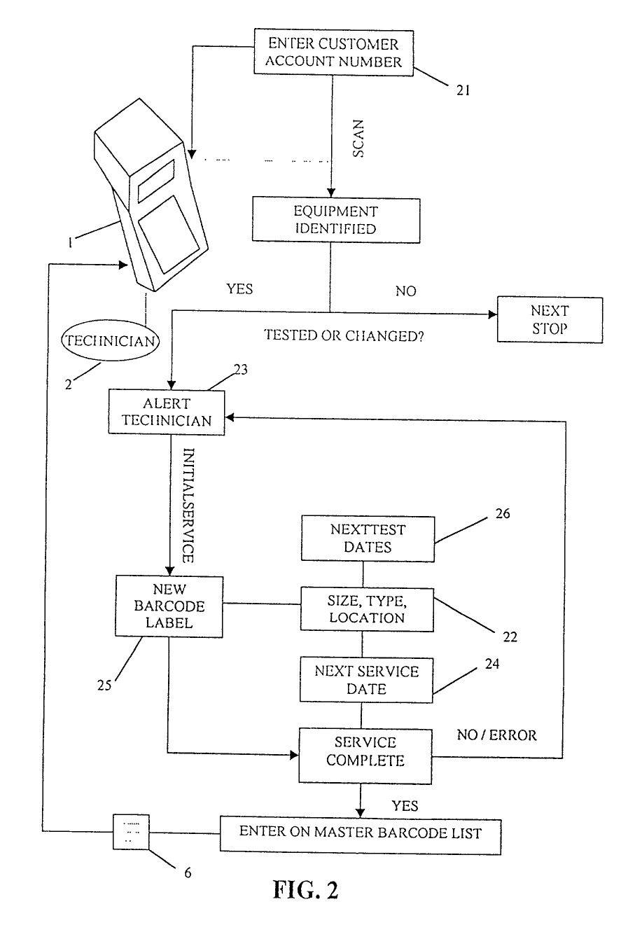

In following FIG. 2, upon arriving at the customer location, a technician 2 enters the customer account number 21. As an initial step, this tracks the time of arrival at the customer location. When a piece of equipment is scanned, the scanner identifies the piece of equipment by name, size, type, test dates, etc. (this information is entered for the initial service). If a piece of equipment is in need of testing or changing, the scanner I beeps as an alert to the technician 23 for what is due. This is achieved by the scanner's ability to match the serial number to previously entered information.

After the initial service, at either new locations or just for new items of equipment, the technician 2 places a new barcode label 25 on the piece of equipment and specifies the size, type, and location of equipment from the master barcode definition list 6. This is read into the scanner 1 and, upon download, discussed below, allows a computer to automatically recognize test frequencies associated with the equipment at a specific site and for a specific customer. The technician 2 enters both the manufacture date and next test dates into the scanner 1 during the initial servicing. The new barcode will contain equipment information recognized by both the computer and the scanner 1 for the month that they were uploaded. This equipment information includes, size, type, and location of the equipment 22, the next service date 24, the next test date 26, and a query for the service completed on the unit, or comments associated with the unit, and the time for service completion.

On all subsequent visits and because the equipment at each customer location is already recognized by the computer, when the technician 2 enters “stop complete” from the master barcode definition list 6, the scanner 1 will recognize if the technician 2 has missed any equipment, thereby eliminating the possibility of missing service on a unit.

The scanner 1 has the capability to recognize a new barcode, or the absence of one, and will prompt the technician 2 to apply a new barcode to enter the appropriate initial servicing information. The scanner 1 will automatically apply this new information into the customer inventory.

Upon completion of the service at the selected customer site, the technician 2 scans the “stop complete” barcode on his master barcode definition list 6. The technician 2 then goes through the following steps to complete the stop, as seen below.

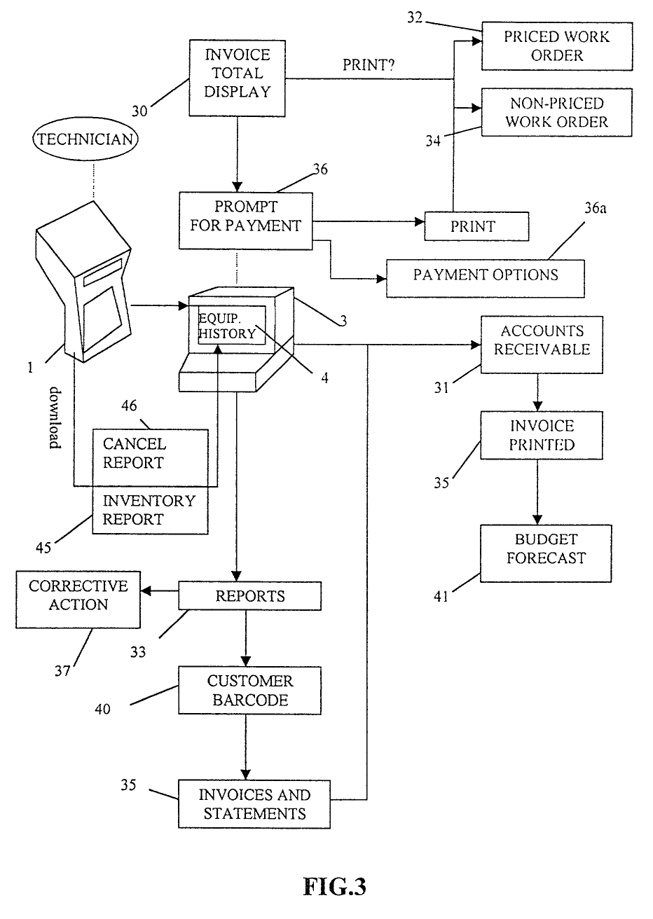

Following FIG. 3 then, the scanner 1 will display the invoice total 30 and prompt the technician 2 whether to print a priced work order 32 or a non-priced work order 34. This is dependent on whether the customer has requested to pay for the service at the customer location.

The scanner 1 will then prompt the technician 2 as to the customer payment terms 36, and the scanner 1 will default to print either a priced 32 or unpriced work order 34. The scanner 1 will then prompt the technician 2 for payment options 36a. If a payment is required the scanner 1 will prompt the technician 2: “Method of Payment? (1) check, (2) cash, (3) credit card.” If the method of payment is a check, a reference number must be entered. For a credit card, the type/issuer must be entered, as well as the expiration date, and the credit card number.

Each technician 2 has a small portable printer at their disposal to assist in issuing the invoices described above, at the customer site. The invoices, as will further be described, can also be transferred from the company site over the Internet by a scrambled ftp.

In one embodiment then, the scanner 1 prompts the technician 2 “ready to print?” At this time the technician 2 ensures proper connection with the scanner 1.

As the technician 2 hits enter, the work order receipt is printed out on two-part paper and signed by the customer. The technician 2 then retains a top copy for records and gives a bottom copy to the customer.

The work order receipt indicates type of payment, reference number and date paid. The work order receipt also has a customizable advertising message printed on the bottom that can be changed as often as needed via the main computer system.

If the scanner 1 fails for any reason, the technician 2 is still able to complete his day by manually entering all the data on paper work orders. Upon arriving back to the building the invoices can be manually entered in the same way.

Upon arriving back at the building, the technician 2 downloads his or her scanner 1 into the cradles connected with the main computer 3. This enables all completed work orders to be entered into as accounting data 7 for transfer to the billing and collection system to generate invoices. All of the service work completed on each given day will download into a report format 33 and into the accounts receivable fields 31 as accounting data for each customer handled that particular day. The technician 2 can delete a customer's inventory as part of a inventory report 45 if, for example, a customer discards any inventory as part of the servicing. The technician 2 can also note in a cancellation reason report 46 and download into the equipment service history 4, whether or not a servicing appointment had been cancelled or missed.

All generated invoices will be printed 35 by office personnel and mailed out daily, thus ensuring quicker turn around on invoices and processing of payments. This enables the generation of complete daily reports 33 of the equipment service history 4, including customer reports, technician reports, mileage reports, company totals, etc. (note: the reports help identify problems that same day in order that immediate corrective action 37 is taken).

At the same time during download, the equipment service history 4 is updated in the computer 3 which then has an up-to-date history for all equipment for all customers, for the next monthly upload.

From this point and continuing, all of the features of the accounting system take over. Reports 33 can be generated through territory, zip codes, and size of account. The accounts receivable 31 maintains work orders to be printed on given frequencies such as: monthly, bimonthly, quarterly, semi-annually, and annually depending on the customers' service needs.

Each customer has an assigned customer barcode 40 to correlate with their given customer number. In accordance with the barcode, technicians have the printed slips with the customer information. When arriving at the customer destination they simply scan the barcode rather than manually punching in the customer number making it quicker as well as eliminating the possibility of entering the wrong account number. Secondly, this barcode is applied to all invoices and statements, enabling the office personnel to scan the barcode when entering accounting data such as payments received.

The scanning program in conjunction with the accounts receivable 31 shall have additional capabilities including special pricing for each customer, which can be changed permanently for any given customer. The scanner 1 will recognize the change in pricing to enable the technicians 2 to print accurately priced invoices 35 at each location if they are needed. The program will enable the forecasting of a budget 41 for any customer based on the current equipment they have for any selected year. Going into a customer account enables a budgeting screen and the computer 3 to prompt for a specific time frame. From here a user can enter a selected time frame as well as selecting different inventory items. The budgeting 41 is set up to utilize the information based on the customer's current pricing. A field is established to enter a discount for a customer if need be. The budgeting 41 also enables the user to access customer budgets without having to go to the customer files.

In the embodiment above then, a technician is a member of a service client using the present system and method provided by a company, which technician can perform the service task and print out, at the customer location, an invoice for the customer. The technician, or the service client employing the technician, would further mail out reports of the equipment service history 4 (FIG. 3) generated after the service task on the equipment is completed in the manner described above. This standard report generation would be a function performed by, for example and now termed herein, a traditional client.

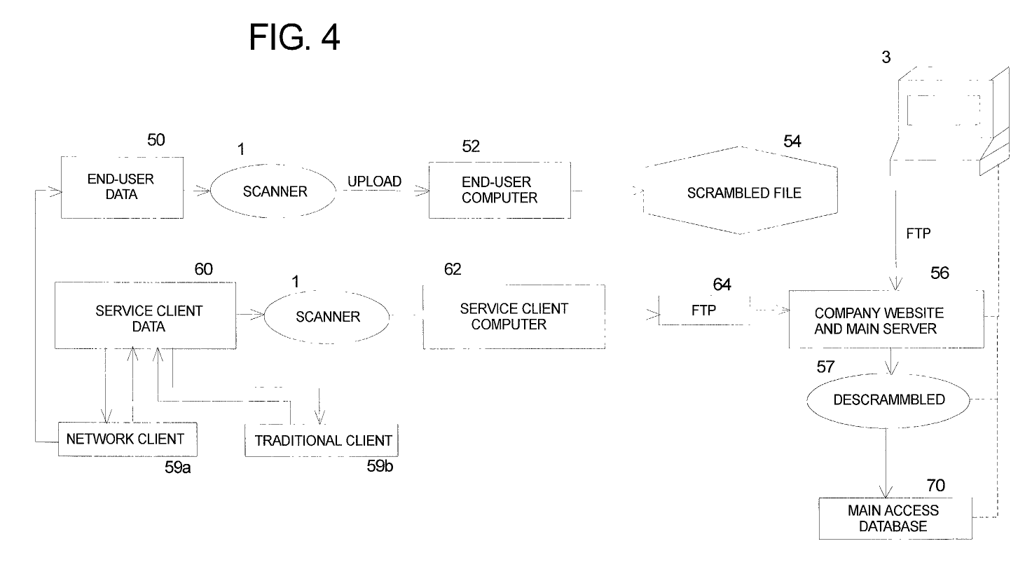

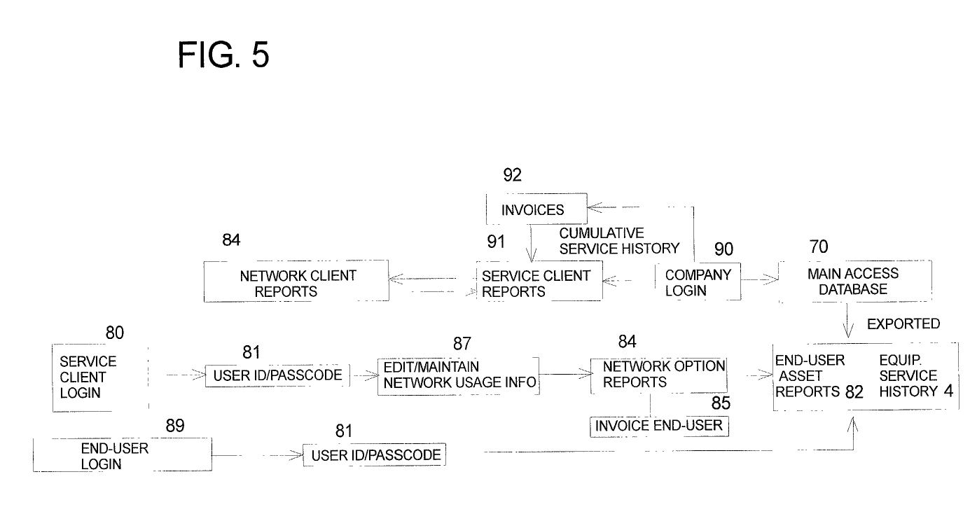

In an alternative embodiment, any resulting reports and invoices and the data collected by the scanner after the service task is performed is collected, organized, and shared remotely by each the company, the service client, and an end-user via a network, such as the Internet. As an improvement then and with reference to FIGS. 4 and 5, an end-user can employ the present system and method provided by the service client. The data collected by both the service client 60 and the end-user 50 can be then be accessed and monitored for report and invoice processing by both the company and the service client 60 via a main access database 70 and company website 56 provided within computer 3 of the company. Thus, the service client 60 can complement itself as a traditional client 59b by purchasing and using an option that allows end-users 50 to perform the service tasks, report generation, and monitoring at their own locations in exchange for a fee. The service client 60 employing the end-user 50 option could then be considered a network client 59a as further described below.

Both end-user data and service client data associated with the equipment information is captured from the hand-held scanner 1 by scanning the appropriate barcode on the equipment being inspected and entering the appropriate inspection information into the scanner 1. For an end-user 50, or third party, the scanner 1 is uploaded into the end-user's local computer 52 running the network client 59 software provided to the service client 60 by the company. The end-user 50 data will be in the form of a scrambled file 54 as to prevent customers from accessing information without first transferring all data via FTP. The file can be scrambled by any type of encryption software implementing an algorithm method. By scrambling the end-user 50 data, the company prohibits the end-user 50 to view the data unless it is transferred by FTP to the Internet, such that the company or service client can track how many users are using and accessing the program. The scrambled file 54 is transferred by FTP into the company website and main server 56 working in conjunction with computer 3. From here the file is automatically descrambled 57 and placed into the main access database 70 for monitored viewing of the equipment service history 4 being an on-line report.

In addition to receiving the FTP from the end-user computer 52, the web site will accept an FTP from the service client computer 62, and this occurring regardless of whether or not the service client is a traditional client 59b or network client 59a. The service client 62 will provide service on the customer units being inspected, and that information is also collected utilizing the hand held scanner 1. On an as needed basis, the service client 62 will upload to the company website and main server 56 additional information for any network client reports 84 as further described.

Because the network client 59a is a bi-product of the traditional client 59b system, the end user 50 can be charged on a monthly fee by their service client 60. Ultimately each service client 60 shall have access to each of their end users 50 having the network capability provided if the service client 60 is a network client 59a. This will enable them to generate monthly invoices to their end-users 50 for revenue. Again, this is the reasoning as to why the file from the scanner 1 must be scrambled so that the end user will not bypass their service client 60, thereby ensuring proper fee dispursal.

As part of the billing and access of the collected data, the service client 60 must then be able to login to a service client login screen 80 on the main access database 70 of the company website and main server 56 (FIG. 4). In this way, the service client can view its customer's (or end user's) asset reports 82, which will be shown as a comprehensive listing of an occurrence of each end-user's login 89 and the appropriate bill to and ship to locations. Other pertinent information includes contact information such as customer number, names, phone numbers, and addresses. Resulting network client reports 84 or other reports showing online equipment service history 4 (FIG. 3), including invoices, can be generated by the service client for end-user viewing and invoicing 85. The service client 60 can edit/maintain end user network usage information 87 as provided by the network client reports 84 after providing a user ID and/or password 81.

Similarly, after a company login 90 to its own main access database 70, the company will charge the service client 60 a fee for the hosting of the online report of the equipment service history 4 accessed by each of their end user in the form of service client reports 91. The company will then have access to reports showing what traditional client 59b customers have network client 59a customers on the company server 56 as well as their customer account numbers so that the company can generate monthly invoices 92 to be billed to the traditional client 59b customers. A comprehensive listing of all traditional client 59b and their account numbers along with the number of network clients 59a for each shall be able to be accessed on the company website and main server 56 by only company personnel.

It is possible to program a general-purpose computer to implement the invention as disclosed herein or another specialized device to implement the invention as discussed. The flowcharts represented herein may represent software function or a logic flow that can be implemented in discrete circuits.

I claim:

1. A method using a computer and a network for tracking and monitoring data collected from a hand-held scanner, comprising the steps of:
receiving said data, wherein said data is associated with equipment information captured from a barcode label read by said hand-held scanner;
placing said data into a main access database within said computer;
arranging said data into an equipment service history report accessible over said network;
allowing a service client to host said equipment service history report; and,
allowing an end-user to login and access said equipment service history report.

2. The method of claim 1, wherein said equipment information includes type of equipment, location of equipment, and servicing or testing dates.

3. The method of claim 1, wherein said data is received by an FTP.

4. The method of claim 1, wherein said data is a scrambled file.

5. The method of claim 4, wherein said scrambled file is descrambled prior to said placing of said data into said main access database.

6. The method of claim 1, further comprising the step of charging a fee to said service client for allowing said service client to host said equipment service history report.

7. The method of claim 1, wherein said equipment service history report includes and invoice.

8. The method of claim 1, further comprising the step of allowing said service client to charge a fee to said end-user for said login and accessing of said equipment service history report.

9. A method using a computer and a network for tracking and monitoring data collected from a hand-held scanner, comprising the steps of:
allowing a service client to collect said data, wherein said data is associated with equipment information captured from a barcode label read by said hand-held scanner, and whereby said service client is a traditional client;
allowing said service client to enable said data to be collected by an end-user, whereby said service client becomes a network client;
receiving said data from either said service client or said end-user;
placing said data into a main access database within a main server and company website of said computer; and,
arranging said data into an equipment service history report accessible over said network by said end-user and said service client.

10. The method of claim 9, wherein said equipment information includes type of equipment, location of equipment, and service or testing dates.

11. The method of claim 9, wherein said data is received by an FTP.

12. The method of claim 9, wherein said data is a scrambled file provided said data is received by said end-user.

13. The method of claim 9, wherein said scrambled file is descrambled prior to said placing of said data into said main access database.

14. The method of claim 9, further comprising the step of charging a fee to said service client.

15. The method of claim 9, further comprising the step of allowing said service client to charge a fee to said end-user based on a usage over said network.

16. A system using a computer and a network for tracking and monitoring data collected from a hand-held scanner, comprising:
means for receiving said data, wherein said data is associated with equipment information captured from a barcode label read by said hand-held scanner;
means for placing said data into a main access database within said computer;
means for arranging said data into an equipment service history report accessible over said network;
means for allowing a service client to host said equipment service history report; and,
means for allowing an end-user to login and access said equipment service history report.

17. The system of claim 16, wherein said data is received by an FTP.

18. The system of claim 16, wherein said data is a scrambled file.

19. The method of claim 16, wherein said equipment service history report includes an invoice.
